(19) United States
(12) Patent Application Publication
(10) Pub. No.: US 2023/0170771 A1
(43) Pub. Date: Jun. 1, 2023

(54) DEVICE AND METHOD FOR CONNECTING SHEET METAL PARTS TO FORM LAMINATION STACKS

(71) Applicant: voestalpine Automotive Components Dettingen GmbH & Co. KG, Dettingen an der Erms (DE)

(72) Inventors: Jochen Lanksweirt, Heidenheim (DE); Heinrich Bursy, Erkenbrechtsweiler (DE)

(21) Appl. No.: 17/995,767

(22) PCT Filed: Apr. 7, 2021
(86) PCT No.: PCT/EP2021/059118

§ 371 Date: Oct. 7, 2022

(30) Foreign Application Priority Data
Apr. 7, 2020 (EP) 20168583.1

(51) Int. Cl. H02K 15/02

(52) U.S. Cl. CPC H02K 15/02

(57) ABSTRACT

A device and a method for connecting sheet metal parts to form lamination stacks in which sheet metal parts are separated from an electrical steel strip using a stamping stage equipped with a punch, wherein the electrical steel strip has a thermally activatable hot-melt adhesive varnish layer on at least one of its flat sides, the separated sheet metal parts are stacked and integrally bonded to one another to form multiple lamination stacks through activation of the hot-melt adhesive varnish layer, wherein a parting compound is applied to the electrical steel strip and/or separated sheet metal part in order to make it easier to divide the stacked sheet metal parts into lamination stacks. In order to achieve advantageous conditions, it is proposed for the punch of the stamping stage to apply a liquid fluid as a parting compound onto the electrical steel strip and/or separated sheet metal part.

### FIELD OF THE INVENTION

The invention relates to a device and method for connecting sheet metal parts to form lamination stacks in which sheet metal parts are separated, in particular detached, from an electrical steel strip with the aid of a stamping stage equipped with a punch, wherein the electrical steel strip has a preferably thermally activatable hot-melt adhesive varnish layer, more particularly a backlack layer, on at least one of its flat sides, the separated sheet metal parts are stacked and integrally bonded to one another to form multiple lamination stacks through activation of the hot-melt adhesive varnish layer, wherein a parting compound is applied to the electrical steel strip and/or separated sheet metal part in order to thus make it easier to divide the stacked sheet metal parts into lamination stacks.

### DESCRIPTION OF THE PRIOR ART

Providing a parting compound on an electrical steel strip coated with a hot-melt adhesive varnish layer is known, for example, from WO2014089593A1. This makes it easier to divide the lamination stacks composed of stacked sheet metal parts. For example, the parting compound is sprayed onto the electrical steel strip before the stamping stage that detaches the sheet metal part from the electrical steel strip and pushes it into a stacking unit.

In other words, the application of the parting compound takes place in a step preceding the detachment—which results in an increased complexity in the synchronization of the application of the parting compound and in the control of the progressive stamping tool. In addition, after the application, the electrical steel strip is moved in the longitudinal direction toward the last stamping stage, which can jeopardize the positioning of the parting compound on the hot-melt adhesive varnish layer. A consequentially imprecise application of the parting compound not only makes it more difficult to divide the stacked lamination stacks from one another, but can also result in the sheet metal parts of a lamination stack undesirably having a reduced cohesion. This seriously interferes with the reproducibility of the method.

### SUMMARY OF THE INVENTION

The object of the invention, therefore, is to improve the reproducibility of such a method from the prior art with a measure for making it easier to divide lamination stacks from one another. This method should also be easier to implement.

Because the punch of the stamping stage applies a parting compound in the form of a fluid onto the electrical steel strip and/or separated sheet metal part, the parting compound on the electrical steel strip does not undergo any movement in the feed direction of the electrical steel strip—also, a parting compound can be applied to the electrical steel strip or to the separated sheet metal part without the occurrence of a movement of the electrical steel strip in its feed direction. Among other things, this can ensure a fixed position and a particularly precise positioning ability of the parting compound, which is especially advantageous if the fluid is a liquid.

This effect not only promotes an ability to precisely divide lamination stacks from one another, but also promotes the stability of the lamination stacks themselves since the parting compound cannot penetrate into unwanted regions of the sheet metal parts and is not applied beyond the desired region of the electrical steel strip—a danger that exists more particularly if the fluid is a liquid.

The method according to the invention can therefore be highly reproducible. In addition, this method is comparatively easy to implement since the application of the parting compound can be simply controlled through the timing of the last stamping stage.

If the punch applies the fluid as the sheet metal part is being separated, then it can itself be used to locally delimit the parting compound application. This makes it possible to further improve the reproducibility of the method.

If the punch tightly adjoins the hot-melt adhesive varnish layer with at least one cutting edge during the application of the fluid and it therefore at least partially delimits the area (F) on the hot-melt adhesive varnish layer onto which the fluid is applied, then it is possible for the cutting edge to prevent the parting compound from escaping laterally. This further simplifies a safe and sufficient application of the parting compound. It is thus possible to achieve a high degree of reproducibility.

Preferably, the fluid is applied using a contact printing process. This can increase the precision of the application of parting compound and can thus make it even easier to exactly divide the sheet metal parts into lamination stacks.

If the punch has a print pressure ing stamp, more particularly a pressure pad or felt, which is able to move relative to its punch bottom and applies the fluid, then the application of the parting compound can be further facilitated—even when there are surface irregularities on the electrical steel strip or on the separated sheet metal part, in order to apply enough parting compound with the aid of the contacting punch.

Alternatively—i.e. instead of the parting compound being applied as described above by means of a physical contact—it is conceivable for the fluid to be sprayed on.

Preferably, the punch has at least one spray nozzle for this purpose, which applies the fluid with a rectangular target area.

Another object of the invention is to create a device for connecting sheet metal parts to form a lamination stack, which device has a simplified design, but is nevertheless able to divide sheet metal parts that are firmly connected to one another into lamination stacks.

By virtue of the fact that the punch of the stamping stage is equipped with the unit that is embodied to apply the parting compound—which is embodied as a fluid, more particularly a liquid—onto the electrical steel strip and/or separated sheet metal part, it is possible to ensure that the coating is applied only to the sheet metal part that is responsible for exactly dividing the interconnected sheet metal parts into lamination stacks. It is also relatively easy for this measure to be provided on the punch, which simplifies the design of the device.

Preferably, the punch has a punch bottom and at least one cutting edge, which protrudes from the punch bottom and, together with the hot-melt adhesive varnish layer, is embodied to form a sealing surface for the fluid. Thus in addition to the detaching function, the cutting edge also serves to delimit the application of fluid onto the hot-melt adhesive varnish layer. This further simplifies a safe and sufficient application of the parting compound. It is thus possible to achieve a high degree of reproducibility.

The device can achieve a particularly high precision of the application if the unit has a pressure stamp, more particularly a pressure pad or felt, which is able to move relative to the punch and is for applying the fluid, wherein the pressure stamp is provided in a recess in the punch bottom of the punch. According to the invention, the application of a sufficient quantity of parting compound with the aid of the contacting punch can also be ensured even when there are surface irregularities.

A contactless application of the parting compound is likewise conceivable in which the unit has a nozzle, more particularly a fan nozzle, for applying the fluid. For example, a uniform distribution of the parting compound over the area to be coated on the electrical steel strip and/or sheet metal part can be ensured by positioning the unit centrally on the punch bottom.

### BRIEF DESCRIPTION OF THE DRAWINGS

The subject matter of the invention will be described in greater detail by way of example based on an embodiment variant shown in the drawings. In the drawings

FIG. 1 shows a schematic view of a device for carrying out the method according to the invention,

FIG. 2 shows a detail view of a stamping stage of the device shown in FIG. 1 in a different movement position,

FIG. 3 shows a top view of the detail view in FIG. 2, and

FIG. 4 shows a top view of FIG. 2 showing a differently shaped sheet metal part.

### WAY TO IMPLEMENT THE INVENTION

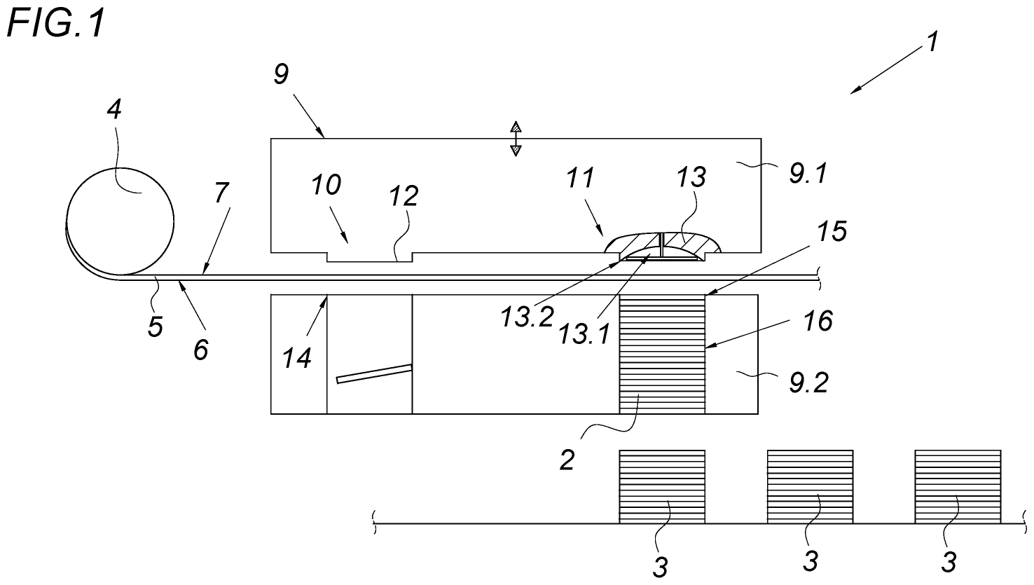

FIG. 1 schematically depicts a device 1 for carrying out the method according to the invention. This device 1 is used for stacking stamped-out sheet metal parts 2 to form lamination stacks 3. For this purpose, an electrical steel strip 5 that has a heat-hardened hot-melt adhesive varnish layer 8—which in the exemplary embodiment is applied to its entire area—on one of its flat sides 6, 7 is unwound from a coil 4; a layer of a hot-melt adhesive varnish can naturally also be provided on both flat sides 6 and 7, likewise over the entire area.

Such a thermosetting or heat-hardened hot-melt adhesive varnish is also referred to as a “backlack”. For example, the hot-melt adhesive varnish can be epoxy resin-based. Preferably, the hot-melt adhesive varnish is a bisphenol-based epoxy resin system with a for example dicyandiamide-based hardener. In particular, the above-mentioned hot-melt adhesive varnish can be a bisphenol-A/epichlorohydrin resin system with dicyanamide as a hardener. This two-stage hardening epoxy resin system on the electrical steel strip is in the B state. The partially cross-linked hot-melt adhesive varnish is still reactive. When heat is supplied, the hot-melt adhesive varnish in the B state reacts further and can thus be converted into the fully cross-linked C state, which is also referred to as baking. This partially cross-linked hot-melt adhesive varnish layer typically has a thickness of a few micrometers.

Multiple sheet metal parts 2 are separated from the hot-melt adhesive varnish-coated electrical steel strip 5 with the aid of a stamping tool 9; it should in general be mentioned that this separating procedure can be a detaching procedure, for example a cutting out, cutting off, notching, trimming, dividing, pushing out, etc. As can also be inferred from FIG. 1, the stamping tool 9, for example a progressive stamping tool or follow-on composite tool here, carries out a detaching procedure with multiple strokes. The stamping tool 9 can thus have more than two stamping stages—which is not shown in the figures.

With a first stamping stage 10, the electrical steel strip 5 is prepared for a punching-out procedure—for example in that a part is cut out in order to thus form notches on the lamination stack 3. This preprocessing of the electrical steel strip also prepares the sheet metal strip for the separation of the sheet metal parts 2.

With a second stamping stage 11, the sheet metal parts 2 are then separated from the electrical steel strip 5 by means of a detaching procedure. Such a detaching procedure can—for example—be a cutting out, cutting off, notching, trimming, dividing, pushing out, etc.

Both stamping stages 10 and 11 have punches 12 and 13, which are part of the upper tool 9.1 of the stamping tool 9. The punches 12 and 13 cooperate with the respective matrixes 14, 15 of the lower tool 9.2 of the stamping tool 9.

With the aid of the stamping stage 11, the separated sheet metal parts 2 are pushed by the pressure of the upper tool 9.1 into a stacking unit 16 and stacked therein. For this purpose, the stacking unit 16 has a guide in the lower tool 9.2. A brace 10 that is not shown in detail is also provided in the guide.

The stacking unit 16 can be actively heated, for example in order to thermally activate the preferably latent hot-melt adhesive varnish layer 8 and produce an adhesive bond or integral bond between the sheet metal parts 2—i.e. to convert the thermosetting hot-melt adhesive varnish layer into the C state. In this connection, it is conceivable for this integral bonding, which is also referred to as a baking of the sheet metal parts 2 into a lamination stack 3, to take place in a different tool or in a furnace or by means of a type of energy supply other than heat, which is not shown.

In order to make the sheet metal parts 2, which exit the stacking unit 16 and are bonded to each other, easier to divide into lamination stacks 3, the electrical steel strip 5 is prepared by applying a parting compound 17—specifically onto the part of the hot-melt adhesive varnish layer 8 on the sheet metal part 2 that is supposed to be the first or last sheet metal part 2 of a lamination stack 3. In the exemplary embodiment, a flowing fluid 17.1, namely a liquid, is used as the parting compound 17.

By contrast with the prior art, this application takes place in the second stamping stage 11—namely in the one that detaches the sheet metal part 2 from the electrical steel strip 5 and thus carries out the separating procedure. According to the invention, the punch 13 of the second stamping stage 11 applies the fluid 17.1 onto the electrical steel strip 5 and/or separated sheet metal part 4. Preferably, this fluid is applied onto the hot-melt adhesive varnish layer 8. It is also conceivable, though, to apply this fluid to an uncoated flat side of the electrical steel strip 5 and/or sheet metal part 2 or also to apply a different coating to the electrical steel strip 5 and/or sheet metal part 2.

For this purpose, the punch 13 has a unit 18, which is provided in a recess 19 on the punch bottom 13.1— namely an inward curvature or hollow of the punch bottom 13.1— and applies the fluid 17.1 onto the hot-melt adhesive varnish layer 8 using a contact printing method. Generally speaking, the fluid 17.1 is applied onto the electrical steel strip 5 and/or sheet metal part 2 so that it is then positioned between two stacked sheet metal parts 2.

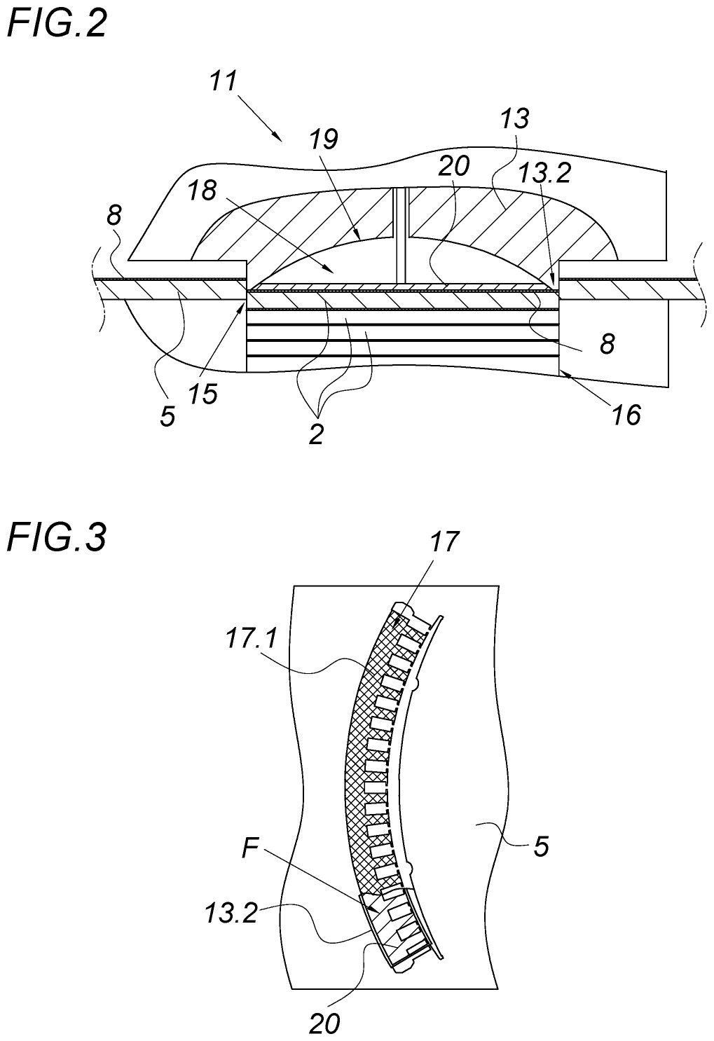

A pressure stamp 20, which is visible in FIG. 2 and is also partially visible in a cutaway view in FIG. 3, is saturated—or simply wetted—with the fluid 17.1 and is pressed against the hot-melt adhesive varnish layer 8. For this purpose, the pressure stamp 20 is moved relative to the punch 13, specifically is slid in linear fashion toward the electrical steel strip 5. In order to impregnate the punch 13 with the fluid, it can be embodied as a printing pad or felt.

As can also be inferred from FIGS. 2 and 3, this parting compound 17 is applied as the sheet metal part 2 is being separated—or in the exemplary embodiment cut out—by the punch 13. As a result, the circumferential cutting edge 13.2 of the punch 13 seals off the contact printing, which prevents the parting compound 17 from escaping. As a result, a sort of cavity forms between the punch bottom 13.1 and the circumferential cutting edge 13.2, which facilitates the contact printing and also ensures a particularly precise printing. This ensures a high degree of reproducibility in order to provide the fluid 17.1 only onto the desired area F.

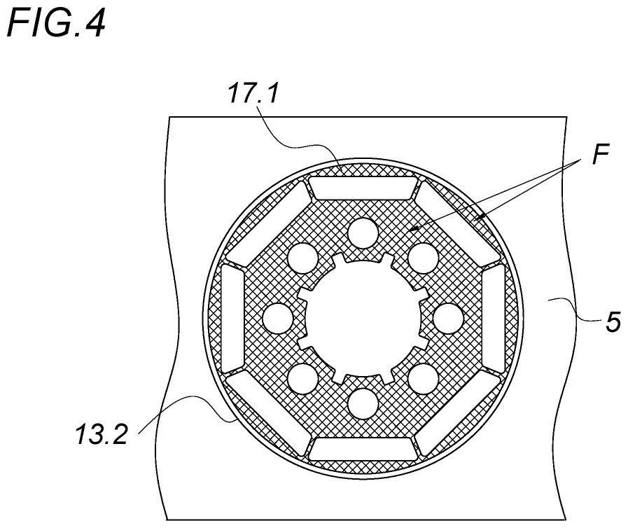

The same is true for the sheet metal part 2, which according to FIG. 4 is shaped differently, for example as a rotor. Here, too, the unit 18 provides the fluid 17.1 only on the desired area F.

In electric machines, for example, the lamination stacks 3 can be used as stators or rotors. But other applications for lamination stacks of this kind are also conceivable, for example when they are used as iron cores for transformers, coils, etc.

1. A method for connecting sheet metal parts to form lamination stacks, comprising:
separating sheet metal parts from an electrical steel strip with the aid of a stamping stage equipped with a punch, wherein the electrical steel strip has a thermally activatable hot-melt adhesive varnish layer on at least one of its flat sides, and the punch applies a liquid fluid as a parting compound onto the electrical steel strip and/or separated sheet metal part, wherein the parting compound makes it easier to divide the stacked sheet metal parts into lamination stacks, and
stacking the separated sheet metal parts and integrally bonding the sheet metal parts to one another to form multiple lamination stacks through activation of the hot-melt adhesive varnish layer.

2. The method according to claim 1, wherein the punch applies the fluid as the sheet metal part is being separated.

3. The method according to claim 2, wherein the punch tightly adjoins the hot-melt adhesive varnish layer with at least one cutting edge during the application of the fluid and the at least one cutting edge therefore at least partially delimits an area on the hot-melt adhesive varnish layer onto which the fluid is applied.

4. The method according to claim 1, wherein the fluid is applied using a contact printing process.

5. The method according to claim 4, wherein the punch has a pressure stamp, which is able to move relative to its punch base and applies the fluid.

6. The method according to claim 1, wherein the fluid is sprayed on.

7. The method according to claim 6, wherein the punch has at least one spray nozzle, which applies the fluid with a rectangular target area.

8. A device for connecting sheet metal parts to form lamination stacks, comprising:
a stamping tool, which has a stamping stage with a punch for separating sheet metal parts from an electrical steel strip that is coated on at least one of its flat sides with a thermally activatable hot-melt adhesive varnish layer,
a stacking unit for stacking the separated sheet metal parts to form multiple lamination stacks, and
a unit, which has a parting compound and is embodied to apply this parting compound onto the electrical steel strip and/or separated sheet metal part in order to thus make it easier to divide the stacked sheet metal parts into lamination stacks, wherein the punch of the stamping stage is equipped with the unit that is embodied to apply the parting compound—which is embodied as a fluid—onto the electrical steel strip and/or separated sheet metal part.

9. The device according to claim 8, wherein the punch has a punch base and at least one cutting edge, which protrudes from the punch base and, together with the hot-melt adhesive varnish layer, is embodied to form a sealing surface for the fluid.

10. The device according to claim 8, wherein the unit has a pressure stamp, which is able to move relative to the punch and applies the fluid, wherein the pressure stamp is provided in a recess in the punch base of the punch.

11. The device according to claim 8, wherein the unit has a nozzle for applying the fluid.
